(19) United States
(12) Patent Application Publication
(10) Pub. No.: US 2004/0009608 A1
(43) Pub. Date: Jan. 15, 2004

(54) Arrays with positioning control

(76) Inventors: Michael P. Caren, Palo Alto, CA (US); William D. Fisher, San Jose, CA (US); Peter G. Webb, Menlo Park, CA (US)

Correspondence Address: AGILENT TECHNOLOGIES,INC., Legal Department, DL429, Intellectual Property Administration, P.O. Box 7599, Loveland, CO, 80537-0599, US

(21) Appl. No.: 10/193,740

(22) Filed: Jul. 10, 2002

(51) Int. Cl. G01N 1/00

(52) U.S. Cl. 436/174; 436/180; 436/164; 435/46; 435/49; 422/102; 422/82.05

(57) ABSTRACT

A method of fabricating an array of different chemical moieties. The method may include ejecting drops containing the different moieties or precursors thereof from an orifice in an ejector head onto a substrate surface spaced from the orifice so as to form the array. The substrate surface may have structures adjacent each of multiple feature locations so as to assist in confining drops ejected onto the surface to the feature locations, which structures comprise channels or deposited raised members adhering to the surface and extending above adjacent feature locations. An array of different chemical moieties is also provided which has features at respective locations on a planar substrate surface having structures comprising channels or deposited raised barriers adhering to the surface, and which structures are adjacent each of multiple feature locations.

### FIELD OF THE INVENTION

This invention relates to arrays, such as polynucleotide or other biopolymer arrays (for example, DNA arrays), which are useful in diagnostic, screening, gene expression analysis, and other applications.

### BACKGROUND OF THE INVENTION

Polynucleotide arrays (such as DNA or RNA arrays), are known and are used, for example, as diagnostic or screening tools. Such arrays include regions of usually different sequence polynucleotides arranged in a predetermined configuration on a substrate. These regions (sometimes referenced as “features”) are positioned at respective locations (“addresses”) on the substrate. The arrays, when exposed to a sample, will exhibit an observed binding pattern. This binding pattern can be detected upon interrogating the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample. Biopolymer arrays can be fabricated by depositing previously obtained biopolymers (such as from synthesis or natural sources) onto a substrate, or by in situ synthesis methods. Methods of depositing obtained biopolymers include dispensing droplets to a substrate from dispensers such as pin or capillaries (such as described in U.S. Pat. No. 5,807,522) or such as pulse jets (such as a piezoelectric inkjet head, as described in PCT publications WO 95/25116 and WO 98/41531, and elsewhere). The substrate is coated with a suitable linking layer prior to deposition, such as with polylysine or other suitable coatings as described, for example, in U.S. Pat. No. 6,077,674 and the references cited therein.

For in situ fabrication methods, multiple different reagent droplets are deposited from drop dispensers at a given target location in order to form the final feature (hence a probe of the feature is synthesized on the array substrate). The in situ fabrication methods include those described in U.S. Pat. No. 5,449,754 for synthesizing peptide arrays, and described in WO 98/41531 and the references cited therein for polynucleotides. The in situ method for fabricating a polynucleotide array typically follows, at each of the multiple different addresses at which features are to be formed, the same conventional iterative sequence used in forming polynucleotides from nucleoside reagents on a support by means of known chemistry. This iterative sequence is as follows: (a) coupling a selected nucleoside through a phosphite linkage to a functionalized support in the first iteration, or a nucleoside bound to the substrate (i.e. the nucleoside-modified substrate) in subsequent iterations; (b) optionally, but preferably, blocking unreacted hydroxyl groups on the substrate bound nucleoside; (c) oxidizing the phosphite linkage of step (a) to form a phosphate linkage; and (d) removing the protecting group (“deprotection”) from the now substrate bound nucleoside coupled in step (a), to generate a reactive site for the next cycle of these steps. The functionalized support (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in a known manner. As can be seen, in situ fabrication involves multiple cycles, whereas the deposition of previously obtained biopolymers is generally one cycle (that is, only one occurrence of probes occurs at each feature).

The foregoing chemistry of the synthesis of polynucleotides is described in detail, for example, in Caruthers, Science 230: 281-285, 1985; Itakura et al., Ann. Rev. Biochem. 53: 323-356; Hunkapillar et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. No. 4,458,066, U.S. Pat. No. 4,500,707, U.S. Pat. No. 5,153,319, U.S. Pat. No. 5,869,643, EP 0294196, and elsewhere. Suitable linking layers on the substrate include those as described in U.S. Pat. Nos. 6,235,488 and 6,258,454 and the references cited therein.

Further details of fabricating biopolymer arrays by depositing either previously obtained biopolymers or by the in situ method are disclosed in U.S. Pat. No. 6,242,266, U.S. Pat. No. 6,232,072, U.S. Pat. No. 6,180,351, and U.S. Pat. No. 6,171,797.

In array fabrication, the quantities of polynucleotide available, whether by deposition of previously obtained polynucleotides or by in situ synthesis, are usually very small and expensive. Additionally, sample quantities available for testing are usually also very small and it is therefore desirable to simultaneously test the same sample against a large number of different probes on an array. These conditions require use of arrays with large numbers of very small, closely spaced features. It is important in such arrays that features actually be present, that they are put down accurately in the desired target pattern, are of the correct size, and that the DNA is uniformly coated within the feature. Failure to meet such quality requirements can have serious consequences to diagnostic, screening, gene expression analysis or other purposes for which the array is being used. However, for economical mass production of arrays with many features it is desirable that they can be fabricated in a short time while maintaining quality.

### SUMMARY OF THE INVENTION

The present invention then, provides in one aspect a method of fabricating an array of features at respective locations on a substrate surface. The method includes ejecting drops containing the different moieties or precursors thereof from an orifice in an ejector head onto the substrate surface spaced from the orifice, so as to form the array. The substrate surface has structures adjacent each of multiple feature locations so as to assist in confining drops ejected onto the surface to the feature locations. Such structures may include channels or raised members adhering to the surface (for example, they may be deposited metal) and extending above adjacent feature locations.

During the array fabrication drops ejected onto the surface for at least some features, may initially extend at least partly over the structures and then move off the structures. During a same cycle a series of drops may be ejected from the head onto the surface for a same feature while the head and substrate surface are in motion with respect to one another, or the series may be ejected from the same orifice.

The structures may have various shapes and dimension. For example, the structures may or may not circumscribe multiple regions each of which contain only one array feature location. For example, such as the structures may be in the form of a grid so as to circumscribe multiple regions in the foregoing manner, and each circumscribed region may have an area no greater than 2 mm² (or not greater than 1 mm², 0.5 mm², 0.1 mm² or 0.01 mm²). The maximum thickness of the structures (that is, the distance they extend above the feature locations) may be no greater than Tmax1 (or even Tmax2 or Tmax3) and they may have a minimum thickness of no less than Tmin1 (or even Tmin2, or Tmin3). Their maximum width may be no greater than Wmax1 (or even Wmax2, or Wmax3) and they may have a minimum width no less than Wmin1 (or even Wmin2 or Wmin3). In the foregoing: Tmax1 may be 1 mm, Tmax2 may be 500 microns, Tmax3 may be 100 microns (although any the Tmax could be a maximum thickness of 2 mm, 0.5 mm, 700 microns, 200 microns, 80 microns, 50 microns, 20 microns, 10 microns, 1 micron, 500 nm, 200 nm, 100 nm or 10 nm); Tmin1 may be 1 micron, Tmin2 may be 5 microns, and Tmin3 may be 10 microns (although any of the Tmin could be a minimum thickness of 10 nm, 100 nm, 200 nm, 500 nm, 1 micron, 10 microns, 20 microns, 50 microns, 70 microns, 100 microns, 200 microns, or 300 microns may be used, or even 0.5 mm); Wmax1, Wmax2 and Wmax3 may have any of the values of any Tmax1, Tmax2, and Tmax3, respectively, although any of them may be any of the values of any of the foregoing maximum thickness (Tmax); Wmin1, Wmin2 and Wmin3 may have any of the values of Tmin1, Tmin2, and Tmin3, respectively, although any of them may be any of the foregoing values of the minimum thickness (Tmin).

During fabrication, the one or more drops ejected onto the surface during a cycle for a feature having an adjacent channel or raised barrier, may have a total volume of no more than 1500 microliters (or no more than 1000, 500, or 200 microliters). Whatever the total volume ejected onto the surface during a cycle for a feature, in the situation where the structures circumscribe regions each with only a single feature, as previously mentioned, such total volume may be selected to occupy an area on the surface less than the area of the region which includes that feature.

Arrays of the present invention may be read in a method of the present invention, which may include exposing the array to a sample and detecting light emitted from individual array features on the substrate surface having the structures. During reading of the array the interrogating light intensity may be decreased at locations of the structures (versus the light intensity at the features), which includes the possibility that no interrogating light illuminates the structures. The detected light from individual array features may be emitted in response to illuminating the array with in interrogating light. Feature locations in a detected light image may be identified based at least in part on the locations of the structures.

The present invention also provides an array of different chemical moieties having at least one thousand features at respective locations on a planar substrate surface which have structures as above described, and which structures are adjacent each of multiple feature locations. Other aspects of the present invention also provide a drop deposition apparatus which may execute an array fabrication method of the present invention, and an array reader which may execute an array reading method of the present invention.

The various aspects of the present invention can provide any one or more of the following and/or other useful benefits. For example, during array fabrication deposited drops can be urged into the correct locations of the features for which they were deposited. The use of cumbersome parts to be assembled and held onto the array substrate may be avoided. The structures on the fabricated array may be used to help locate the features in a detected light image of the array following reading.

### BRIEF DESCRIPTION OF THE DRAWINGS

Embodiments of the invention will now be described with reference to the drawings, in which:

FIG. 1 illustrates a substrate carrying multiple arrays, such as may be fabricated by methods of the present invention;

FIG. 2 is an enlarged view of a portion of FIG. 1 showing ideal spots or features;

FIG. 3 is an enlarged illustration of a portion of the substrate in FIG. 2;

FIG. 4 illustrates how an array may be fabricated without use of structures on a substrate surface;

FIG. 5 illustrates operation of substrate surface structures in an array of the present invention;

FIGS. 6-9 illustrate examples of an operation of structures in arrays of the present invention;

FIG. 10 shows some alternate structures in arrays of the present invention;

FIGS. 11 and 12 illustrate still further structures of arrays of the present invention and their operation; and

FIG. 13 shows an apparatus for executing a method of the present invention to fabricate arrays of the present invention.

Unless otherwise indicated, drawings are not to scale. To facilitate understanding, the same reference numerals have been used, where practical, to designate elements that are common to the figures.

### DETAILED DESCRIPTION OF EMBODIMENTS OF THE INVENTION

In the present application, unless a contrary intention appears, the following terms refer to the indicated characteristics. A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups). A “peptide” is used to refer to an amino acid multimer of any length (for example, more than 1, 10 to 100, or more amino acid units). A biomonomer fluid or biopolymer fluid refers to a liquid containing either a biomonomer or biopolymer, respectively (typically in solution).

A “pulse jet” is a device which can dispense drops in the formation of an array. Pulse jets operate by delivering a pulse of pressure (such as by a piezoelectric or thermoelectric element) to liquid adjacent an outlet or orifice such that a drop will be dispensed therefrom. When the arrangement, selection, and movement of “dispensers” is referenced herein, it will be understood that this refers to the point from which drops are dispensed from the dispensers (such as the outlet orifices of pulse jets). A “drop” in reference to the dispensed liquid does not imply any particular shape, for example a “drop” dispensed by a pulse jet only refers to the volume dispensed on a single activation. A drop which has contacted a substrate is often referred to as a “deposited drop” or the like, although sometimes it will be simply referenced as a drop when it is understood that it was previously deposited. Detecting a drop “at” a location, includes the drop being detected while it is traveling between a dispenser and that location, or after it has contacted that location (and hence may no longer retain its original shape) such as capturing an image of a drop on the substrate after it has assumed an approximately circular shape of a deposited drop.

An “array”, unless a contrary intention appears, includes any one, two or three dimensional arrangement of addressable regions bearing a particular chemical moiety to moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one which is evaluated by the other (thus, either one could be an unknown mixture of polynucleotides to be evaluated by binding with the other). An “array layout” refers collectively to one or more characteristics of the features, such as feature positioning, one or more feature dimensions, and some indication of a moiety at a given location. “Hybridizing” and “binding”, with respect to polynucleotides, are used interchangeably.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

It will also be appreciated that throughout the present application, that words such as “top”, “upper”, and “lower” are used in a relative sense only. “Fluid” is used herein to reference a liquid. Reference to a singular item, includes the possibility that there are plural of the same items present. Furthermore, when one thing is “moved”, “moving”, “re-positioned”, “scanned”, or the like, with respect to another, this implies relative motion only such that either thing or both might actually be moved in relation to the other. For example, when dispensers are “moved” relative to a substrate, either one of the dispensers or substrate may actually be put into motion by the transport system while the other is held still, or both may be put into motion. All patents and other cited references herein, are incorporated into this application by reference except insofar as any may conflict with the present application (in which case the present application prevails).

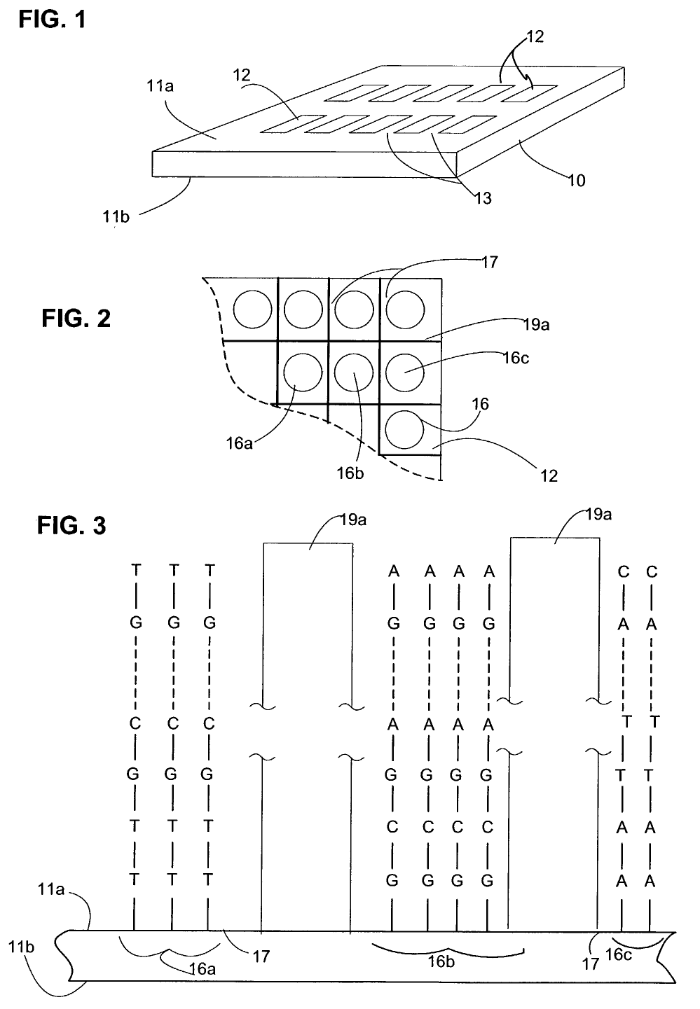

Referring first to FIGS. 1-3, typically methods and apparatus of the present invention produce a contiguous planar substrate 10 carrying one or more arrays 12 disposed across a front surface 11a of substrate 10 and separated by inter-array areas 13. A back side 11b of substrate 10 does not carry any arrays 12. The arrays on substrate 10 can be designed for testing against any type of sample, whether a trial sample, reference sample, a combination of them, or a known mixture of polynucleotides (in which latter case the arrays may be composed of features carrying unknown sequences to be evaluated). While ten arrays 12 are shown in FIG. 1 and the different embodiments described below may use substrates with particular numbers of arrays, it will be understood that substrate 10 and the embodiments to be used with it, may use any number of desired arrays 12. Similarly, substrate 10 may be of any shape, and any apparatus used with it adapted accordingly. Depending upon intended use, any or all of arrays 12 may be the same or different from one another and each will contain multiple spots or features 16 of biopolymers in the form of polynucleotides. A typical array may contain from more than ten, more than one hundred, more than one thousand or ten thousand features, or even more than from one hundred thousand features. All of the features 16 may be different, or some could be the same (for example, when any repeats of each feature composition are excluded the remaining features may account for at least 5%, 10%, 20%, or 50% of the total number of features). In the case where arrays 12 are formed by the conventional in situ or deposition of previously obtained moieties, as described above, by depositing for each feature a droplet of reagent in each cycle such as by using a pulse jet such as an inkjet type head, interfeature areas 17 will typically be present which do not carry any polynucleotide. It will be appreciated though, that the interfeature areas 17, when present, could be of various sizes and configurations. Each feature carries a predetermined polynucleotide (which includes the possibility of mixtures of polynucleotides). As per usual, A, C, G, T represent the usual nucleotides. It will be understood that there may be a linker molecule (not shown) of any known types between the front surface 11a and the first nucleotide.

Features 16 can have widths (that is, diameter, for a round spot) in the range from a minimum of about 10 μm to a maximum of about 1.0 cm. In embodiments where very small spot sizes or feature sizes are desired, material can be deposited according to the invention in small spots whose width is in the range about 1.0 μm to 1.0 mm, usually about 5.0 μm to 500 μm, and more usually about 10 μm to 200 μm. Spot sizes can be adjusted as desired, by using one or a desired number of pulses from a pulse jet to provide the desired final spot size. Features which are not round may have areas equivalent to the area ranges of round features 16 resulting from the foregoing diameter ranges. The probes of features 16 are typically linked to substrate 10 through a suitable linker, not shown.

Each array 12 may cover an area of less than 100 cm², or even less than 50, 10 or 1 cm². In many embodiments, substrate 10 will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm.

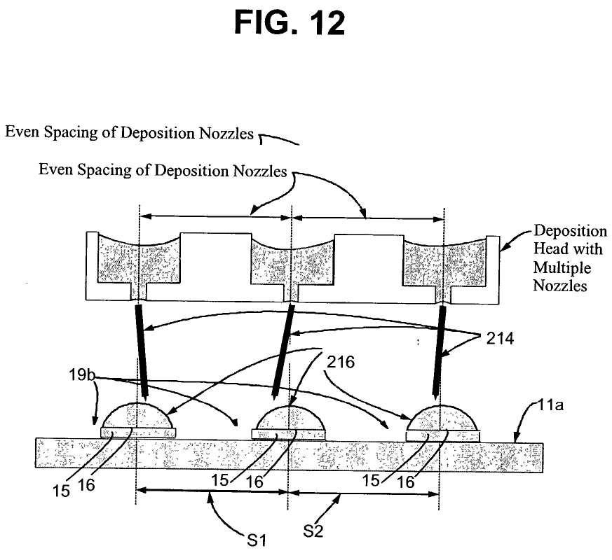

As shown more clearly in FIGS. 1 and 2 each array 10 includes a rectilinear grid of structures (see FIG. 2 in particular) in the form of raised members 19a adhering to front surface 11a and extending above the locations of features 16 (that is, above the locations on front surface 11a at which features 16 are located) and also extend above the features 16 themselves. Members 19a may be formed from a metal, such as chrome, which is deposited by any suitable method (such as vacuum deposition or sputtering, through a mask) onto front surface 11a. For example, the structures may be in the form of a grid so as to circumscribe multiple regions in the foregoing manner, and each circumscribed region may have an area no greater than 2 mm² (or not greater than 1 mm², 0.5 mm², 0.1 mm² or 0.01 mm²). The maximum thickness of the structures (that is, the distance they extend above the substrate surface) may be no greater than Tmax1 (or even Tmax2 or Tmax3) and they may have a minimum thickness of no less than Tmin1 (or even Tmin2, or Tmin3). Their maximum width may be no greater than Wmax1 (or even Wmax2, or Wmax3) and they may have a minimum width no less than Wmin1 (or even Wmin2 or Wmin3). Other structures, such as channels 19b, may be used instead of the structures in the form of raised members. Such channels are further discussed below in connection with FIG. 12 and may have any of the dimensions discussed in connection with the raised members (although the thickness in the case of channels 19b, will be measured as the distance which they extend below the locations at which features 16 are formed).

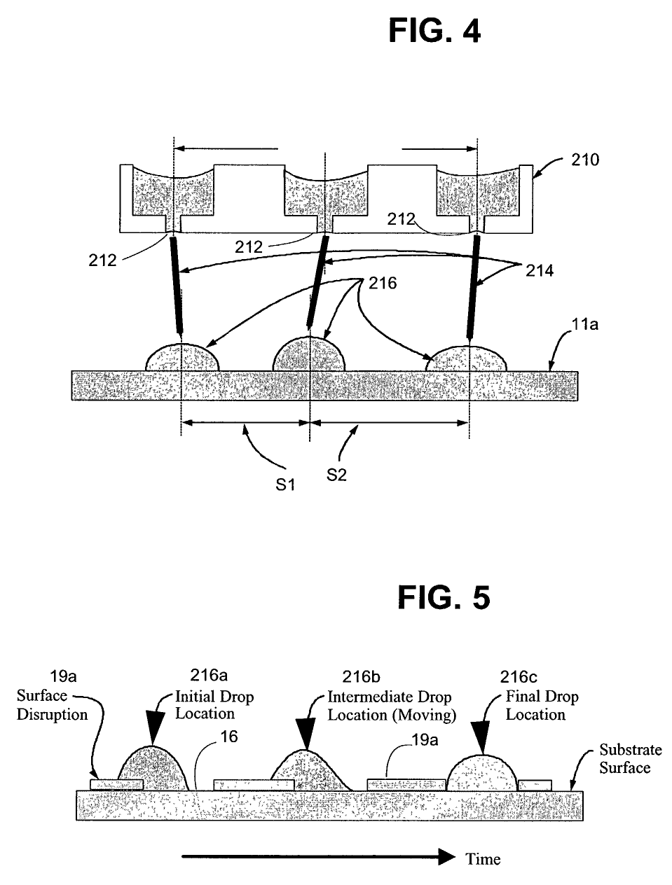

The operation of structures to assist in confining drops ejected onto surface 11a to the feature locations, can be understood by first considering FIG. 4. FIG. 4 illustrates a head 210a or 210b ejecting drops from respective pulse jet nozzles 212 spaced from front surface 11a of substrate 10, while the head is moving (left, right, or in or out of the page as viewed in FIG. 4) with respect to substrate surface 11a. In FIG. 4 the deposited drops 216 are deposited at respective feature locations on surface 11a. There are two main sources of error in drop placement onto surface 11a during such action. In particular, these are deposition head firing inaccuracies and irregular substrate surface conditions. With regard to firing inaccuracies, while pulse jets can generally dispense fairly consistent drop volumes, they often have a very poor ability to fire straight regardless of whether they are thermal or piezoelectric pulse jets. This is illustrated in the different drop trajectories 114 in FIG. 4. The result is that deposited drops 216 on surface 11a from a nozzle 112 of a pulse jet, will tend to fall within a circle of error from the desired target location and will therefore tend to have uneven spacings such as S1 and S2 in FIG. 4. While moving the head closer to the substrate surface 11a may help reduce the circle of error for the drop placements, this does not eliminate it and the reduction may not be enough without the head travelling too close. This circle of error will limit how closely the features 16 within an array being fabricated can be arranged, since as feature locations move closer drops deposited for different adjacent features may eventually overlap resulting in very undesirable feature overlap.

With regard to irregular conditions on substrate surface 11a, such can cause deposited drops to move or wick to any aberrations on the surface it touches. This also tends to change the actual shape and position of the deposited drops and potentially cause them to combine (which would destroy the structure of the array). Again, as array densities increase it is very important to keep the drops separated. As can be appreciated from FIG. 4, if any of the drops on surface 11a move or wick according to local surface conditions, this will also result in errors in drop placement on surface 11a with consequent misplacement of features 16 being formed or worse, possible overlap of them during fabrication.

In addition to pulse jet firing inaccuracies and surface conditions, another problem in correct placement of features 16 can result in those situations where it is necessary to create a larger size of deposited drops 216 at a feature location on substrate surface 11a than can be created with a single drop deposition from a nozzle 112. The creation of larger deposited drops 216 may require multiple fires (that is, multiple drop ejections) from a nozzle 112. Since it is undesirable to stop the motion of the deposition system 210 so that the multiple fires from a same nozzle 112 will land precisely on top of each other on surface 11a, a series of multiple drops are rapidly ejected from a same nozzle 112 while the deposition system 210 is moving with respect to substrate 10. Generally, the timing of the drops fired out of a nozzle 112 is selected such that the centroid of a resulting large drop formed on surface 11a from a deposited series of drops, is at the desired location on substrate surface 11a. However, the rate at which the series of drops for a same feature can be deposited, and the speed of the deposition system 210 with respect to surface 11a, will effect the shape of the resulting large drop formed on the substrate surface from a coalesced series of drops. As a result, even though the centroid of the resulting large drop on surface 11a may be at the target location, the resulting large drop may be too spread out and possibly touch other drops on the surface which is again undesirable.

One way in which barriers such as raised members 19a may inhibit one or more of the above effects, is though to occur as illustrated in FIG. 5. FIG. 5 illustrates the movement over time of an initially deposited drop 216a resulting from a drop ejected onto surface 11a. In particular, initially deposited drop 216a which extends at least partly over a structure (such as a raised member 19a) will then tend to move off such structure over time to form drops 216b and 216c to minimize its surface energy. This is particularly true where the surface 11a at a location of a feature 16 to be formed has a lower surface energy than the structure itself (that is, drop 216 has a lower contact angle with the location of a feature 16 than with a structure). This can be obtained by the selection of appropriate materials for the structures and surface 11a (for example, by providing a lyophilic coating as part of surface 11a). As a result of the foregoing the structure effectively provides a non-wetting area for the initially deposited drop 216a, thereby effecting the contact angle and surface tension of the drop which causes it to move to a minimum energy profile as provided by forming drop 216c which is entirely on a location of a feature 16.

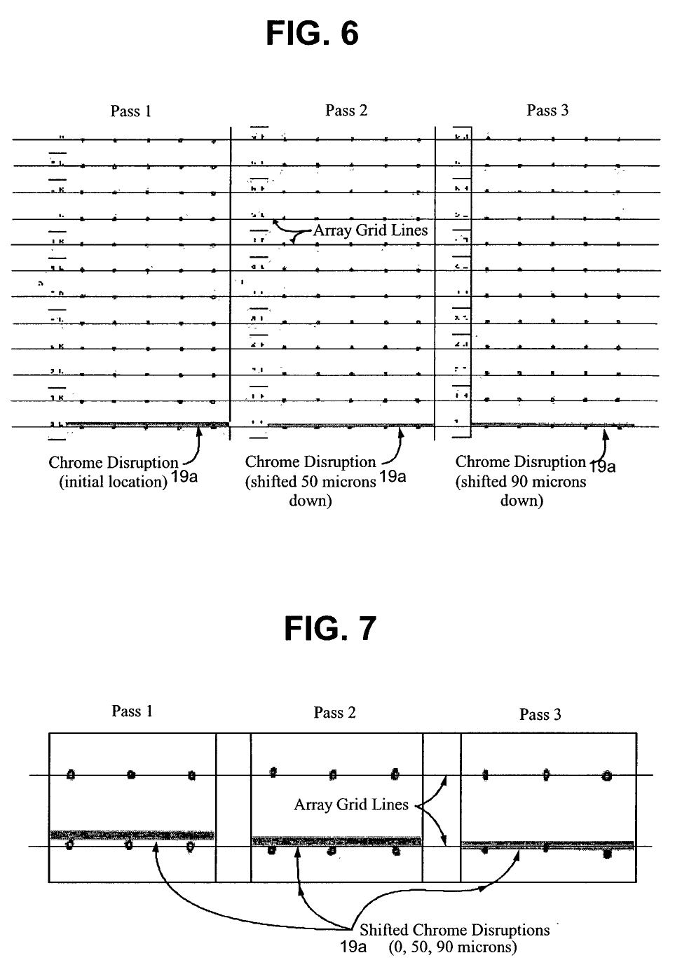

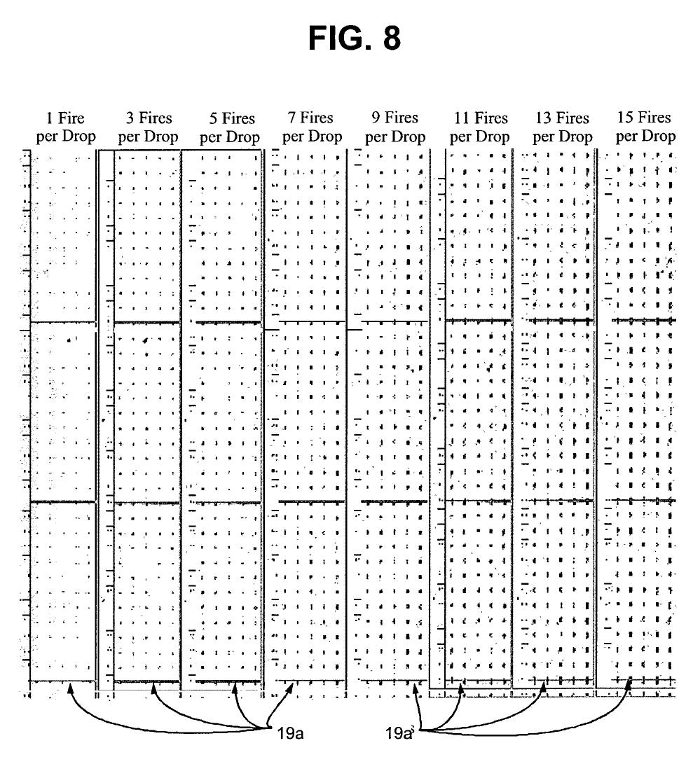

An example of how structures such as members 19a assist in confining drops ejected onto surface 11a to feature locations, is provided in FIGS. 6 through 9. In FIGS. 6-9 raised members 19a, rather than forming a grid, are in the form of lines which do not circumscribe locations of features 16. FIG. 6 is an image of a substrate surface 11a resulting from three different passes of deposition head with five nozzles 112 firing drops as the head was moved from the top of the figure to the bottom. In FIG. 6 a raised member 19a of deposited chromium adheres to the substrate surface 11a at a location before the twelfth row of drops, and appears as a thick gray line in FIG. 6. In the first pass, the raised member 19a is positioned just above the location of the deposited drops 216 (all of which ideally would be at respective locations of features 16). In the second pass member 19a is moved 50 microns down in FIG. 6 forcing the center of the deposited drops 216 to move down also. Finally in the third pass, the chrome disruption is positioned 90 microns down centering it along a desired grid location for the features 16, and is at the limit of still being able to influence the drop placements. A magnified view around the raised members 19a for the center of each pass is shown in FIG. 7. As can be seen from FIGS. 6 and 7 the deposited drops 216 are moved downward by the shift of structure 19a. Pass 3 in FIGS. 6 and 7 illustrates the limiting case where the deposited drop locations 216 since their size is on the same order of magnitude as the thickness of the structure 19a.

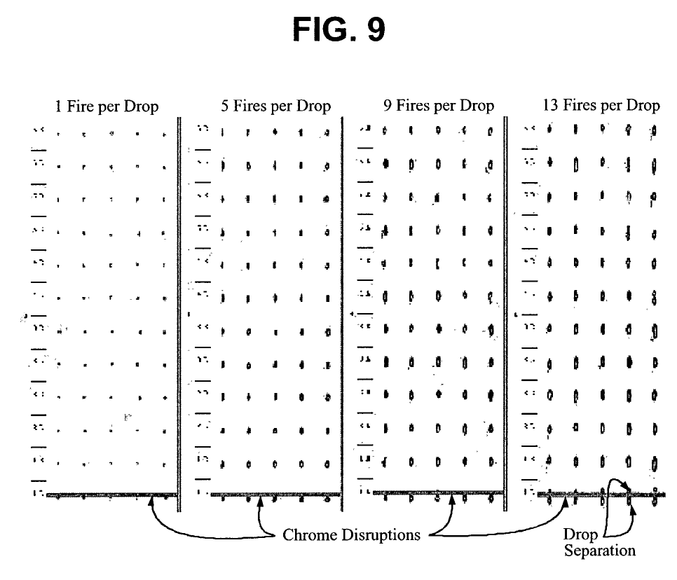

The presence of structures on surface 11a can also constrain a deposited drop 216 which is formed by a series of drops from a same orifice 212 while head system 210 is in motion, from spreading out too far. This is illustrated in FIGS. 8 and 9. In FIG. 8 substrate surface 11a is shown with different sizes of deposited drops 216 that where created using a deposition head with five nozzles across each of which ejected a series of drops (with different numbers of drops) while the head system 210 was moving from the top of FIG. 8 to the bottom. When looking across FIG. 8 from left to right, the more ejected drops in a series for a deposited drop 216, the larger the deposited drop 216 on the substrate surface 11a. From 1 to 15 drops per deposited drop 216 were ejected onto surface 11a, proceeding from the first through eighth columns (from left to right) in FIG. 8. As can be seen the shape of the deposited drops 216 become more oblong with an increasing number of drops in a series for a deposited drop. Before every twelfth row of deposited drops going down in FIG. 8, there is a structure in the form of raised member 19a which appears as a gray horizontal line. As can be seen from FIG. 8, with up to 9 drops per deposited drop, the deposited drops not only remain below the raised chromium member but also maintain a consistent round shape. After 9 drops per deposited drop, the drops are actually split by the raised members 19a resulting in the deposited drop being divided in two across the thickness of members 19a. The foregoing effects can be better seen in FIG. 9, which is an enlarged view of a portion of FIG. 8.

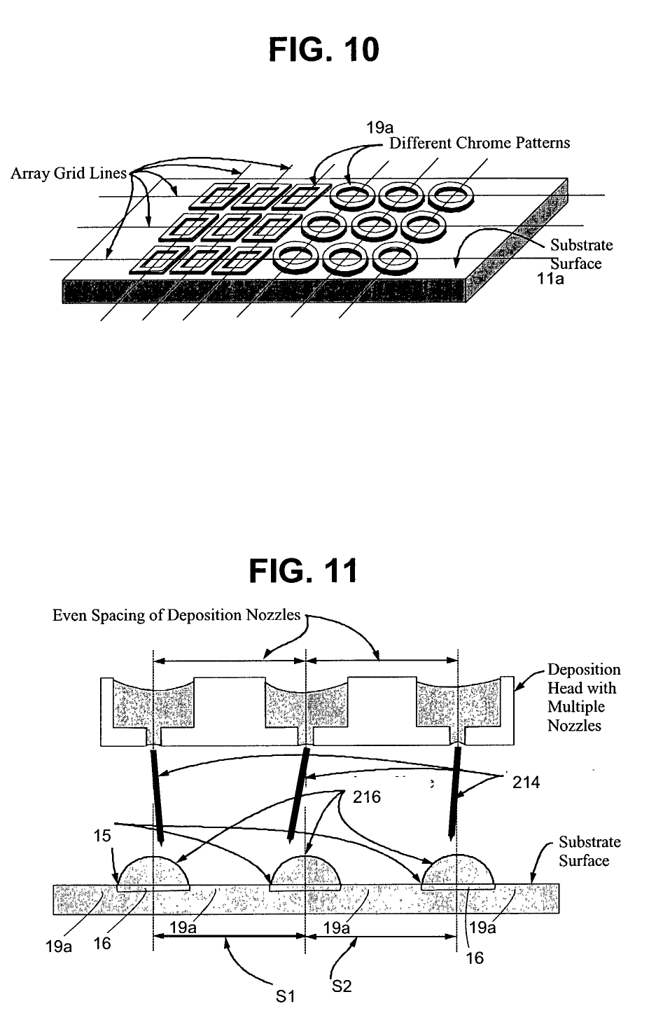

FIG. 10 illustrates further structures in the form of raised members 19a, which also circumscribe regions each of which contain only one array feature location. However, in FIG. 10 the structures are in the form of independent rectangles or circles rather than a grid as in FIG. 2.

FIG. 11 is view similar to that of FIG. 4 but with the surface 11a carrying raised members 19a and illustrating how the raised members 19a are believed to assist in confining deposited drops to the locations of features 16. However, in FIG. 11 the raised members 19a are integral (that is, one-piece) with the remainder of substrate 10 and may be formed by taking a solid substrate planar on both sides and etching channels 15 into the front surface 11a. Note that in this configuration the raised members 19a extend above locations of features 16 which locations are at the bottom of channels 15, and that the center-to-center spacings S1, S1 between adjacent features 16 are now equal.

FIG. 12 is a view similar to FIG. 11 but illustrates a different embodiment of an array and method of the present invention. In FIG. 12 the structures are in the form of channels 19b, with locations of features 16 being on raised portions 15 of front surface 11a. Raised portions 15 may, for example, be a deposited material adhering to front surface 11a. Such raised portions 15 may be a metal, such as chromium, vacuum deposited or sputtered through a mask. Note that since the structures in FIG. 12 are in fact channels 19b, they extend below the locations of adjacent features 16 (versus raised members 19a in FIG. 11 which extend above the locations of adjacent features 16). Channels 19b may take on any of the configurations of raised members 19a described above (grid, lines, circles, squares, and the like) and may have thickness and width ranges the same as any of those described above in connection with raised members 19a. Note that in for channels their thickness will be the distance they extend below the locations of the adjacent features 16. Thus, in FIG. 12 the thickness of channels 19b will be equal to that of raised portions 15.

For the purposes of the discussions below, it will be assumed (unless the contrary is indicated) that the array being formed in any case is a polynucleotide array formed by the deposition of previously obtained polynucleotides using pulse jet deposition units. However, the apparatus and methods can be applied to arrays of other polymers or chemical moieties generally, whether formed by multiple cycle in situ methods or deposition of previously obtained moieties.

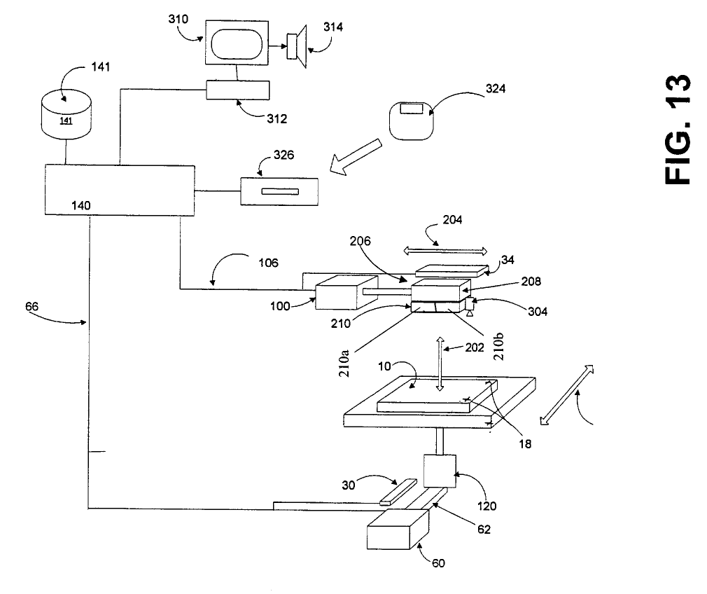

Referring to FIG. 13 an apparatus of the present invention includes a substrate station 20 on which can be mounted a substrate 10. Pins or similar means (not shown) can be provided on substrate station 20 by which to approximately align substrate 10 to a nominal position thereon. Substrate station 20 can include a vacuum chuck connected to a suitable vacuum source (not shown) to retain a substrate 10 without exerting too much pressure thereon, since substrate 10 is often made of glass or silica.

A movable head unit 206 includes a dispensing head system 210 (with two heads 210a, 210b) retained by a head retainer 208. Head unit 206 includes any further components that move in conjunction with head system 210. Head system 210 can be positioned at any position facing substrate 10 by means of a transport system. The transport system includes a carriage 62 connected to a first transporter 60 controlled by processor 140 through line 66, and a second transporter 100 controlled by processor 140 through line 106. Transporter 60 and carriage 62 are used to execute one axis positioning of station 20 (and hence mounted substrate 10) facing the dispensing head system 210, by moving it in the direction of nominal axis 63, while transporter 100 is used to provide adjustment of the position of head retainer 208 in a direction of nominal axis 204. In this manner, head system 210 can be scanned line by line, by scanning along a line over substrate 10 in the direction of axis 204 using transporter 100 while substrate 10 is stationary, while line by line movement of substrate 10 in a direction of axis 63 is provided by transporter 60 while head system 210 is stationary. Head system 210 may also optionally be moved in a vertical direction 202, by another suitable transporter (not shown). However, it will be appreciated that other scanning configurations could be used. Also, it will be appreciated that both transporters 60 and 100, or either one of them, with suitable construction, could be used to perform the foregoing scanning of head system 210 with respect to substrate 10. Thus, when the present application refers to “positioning”, “moving”, or “displacing” or the like, one element (such as head system 210) in relation to another element (such as one of the stations 20 or substrate 10) it will be understood that any required moving can be accomplished by moving either element or a combination of both of them. An encoder 30 communicates with processor 140 to provide data on the exact location of substrate station 20 (and hence substrate 10 if positioned correctly on substrate station 20), while encoder 34 provides data on the exact location of holder 208 (and hence head system 210 if positioned correctly on holder 208). Any suitable encoder, such as an optical encoder, may be used which provides data on linear position. Angular positioning of substrate station 20 is provided by a transporter 120, which can rotate substrate station 20 about axis 202 under control of processor 140. Typically, substrate station 20 (and hence a mounted substrate) is rotated by transporter 120 under control of processor 140 in response to an observed angular position of substrate 10 as determined by processor 140 through viewing one or more fiducial marks on substrate 10 (particularly fiducial marks 18) with a camera (not shown). This rotation will continue until substrate 10 has reached a predetermined angular relationship with respect to dispensing head system 210. In the case of a square or rectangular substrate, the mounted substrate 10 will typically be rotated to align one edge (length or width) with the scan direction of head system 210 along axis 204.

Head system 210 may contain one or more (for example, two or three) heads mounted on the same head retainer 208. Each such head may be the same in construction as a head type commonly used in an ink jet type of printer. Each ejector is in the form of an electrical resistor operating as a heating element under control of processor 140 (although piezoelectric elements could be used instead). Each orifice with its associated ejector and portion of the chamber, defines a corresponding pulse jet with the orifice acting as a nozzle. It will be appreciated that head system 210 could have any desired number of pulse jets (for example, at least fifty or at least one hundred pulse jets). In this manner, application of a single electric pulse to an ejector causes a droplet to be dispensed from a corresponding orifice. Certain elements of each head can be adapted from parts of a commercially available thermal inkjet print head device available from Hewlett-Packard Co. as part no. HP51645A. One type of head and other suitable dispensing head designs are described in more detail in U.S. patent application entitled “A MULTIPLE RESERVOIR INK JET DEVICE FOR THE FABRICATION OF BIOMOLECULAR ARRAYS” Ser. No. 09/150,507 filed Sep. 9, 1998. However, other head system configurations can be used such as that described in U.S. patent application Ser. No. 10/022088 titled “Multiple Inkjet Die, Multiple Reservoir Printhead Manufacturing Using Single Housing” by Daquino et al. filed Dec. 18, 2001 and owned by the assignee of the present application.

As is well known in the ink jet print art, the amount of fluid that is expelled in a single activation event of a pulse jet, can be controlled by changing one or more of a number of parameters, including the orifice diameter, the orifice length (thickness of the orifice member at the orifice), the size of the deposition chamber, and the size of the heating element, among others. The amount of fluid that is expelled during a single activation event is generally in the range about 0.1 to 1000 pL, usually about 0.5 to 500 pL and more usually about 1.0 to 250 pL. A typical velocity at which the fluid is expelled from the chamber is more than about 1 m/s, usually more than about 10 m/s, and may be as great as about 20 m/s or greater. As will be appreciated, if the orifice is in motion with respect to the receiving surface at the time an ejector is activated, the actual site of deposition of the material will not be the location that is at the moment of activation in a line-of-sight relation to the orifice, but will be a location that is predictable for the given distances and velocities.

The apparatus further includes a sensor in the form of a camera 304, to monitor dispensers for errors (such as failure to dispense droplets) by monitoring for drops dispensed onto substrate 10 when required of a dispenser. Camera 304 can also image the structures on surface 11a. Camera 304 communicates with processor 140, and should have a resolution that provides a pixel size of about 1 to 100 micrometers and more typically about 4 to 20 micrometers or even 1 to 5 micrometers. Any suitable analog or digital image capture device (including a line by line scanner) can be used for such camera, although if an analog camera is used processor 140 should include a suitable analog/digital converter. A detailed arrangement and use of such a camera to monitor for dispenser errors, is described in U.S. Pat. No. 6,232,072. Particular observations techniques are described, for example, in co-pending U.S. patent application Ser. No. 09/302,898 filed Apr. 30, 1999 by Caren et al., assigned to the same assignee as the present application, incorporated herein by reference. Monitoring can occur during formation of an array and the information used during fabrication of the remainder of that array or another array, or test-print patterns can be run before array fabrication. A display 310, speaker 314, and operator input device 312, are further provided. Operator input device 312 may, for example, be a keyboard, mouse, or the like. Processor 140 has access to a memory 141, and controls print head system 210 (specifically, the activation of the ejectors therein), operation of the transport system, operation of each jet in print head system 210, capture and evaluation of images from the camera 304, and operation display 310 and speaker 314. Memory 141 may be any suitable device in which processor 140 can store and retrieve data, such as magnetic, optical, or solid state storage devices (including magnetic or optical disks or tape or RAM, or any other suitable device, either fixed or portable). Processor 140 may include a general purpose digital microprocessor suitably programmed from a computer readable medium carrying necessary program code, to execute all of the functions required of it as described below. It will be appreciated though, that when a “processor” such as processor 140 is referenced throughout this application, that such includes any hardware and/or software combination which will perform the required functions. Suitable programming can be provided remotely to processor 140, or previously saved in a computer program product such as memory 141 or some other portable or fixed computer readable storage medium using any of those devices mentioned below in connection with memory 141. For example, a magnetic or optical disk 324 may carry the programming, and can be read by disk reader 326.

Operation of the apparatus of FIG. 13 in accordance with a method of the present invention, will now be described. First, it will be assumed that memory 141 holds a target drive pattern. This target drive pattern is the instructions for driving the apparatus components as required to form the target array (which includes target locations and dimension for each spot) on substrate 10 and includes, for example, movement commands to transporters 60 and 100 as well as firing commands for each of the pulse jets in head system 210 coordinated with the movement of head system 210 and substrate 10, as well as instructions for which polynucleotide solution (or precursor) is to be loaded in each pulse jet (that is, the “loading pattern”). This target drive pattern is based upon the target array pattern and can have either been input from an appropriate source (such as input device 312, a portable magnetic or optical medium, or from a remote server, any of which communicate with processor 140), or may have been determined by processor 140 based upon an input target array pattern (using any of the appropriate sources previously mentioned) and the previously known nominal operating parameters of the apparatus. Further, it will be assumed that drops of different biomonomer or biopolymer containing fluids (or other fluids) have been placed at respective regions of a loading station (not shown). Operation of the following sequences are controlled by processor 140, following initial operator activation, unless a contrary indication appears.

For any given substrate 10, the operation is basically as follows: (i) determine a target drive pattern (if not already provided) to obtain target array pattern, based on nominal operating parameters and target polynucleotide array pattern; (ii) deposit a test pattern of drops from all the dispensers and evaluate the resulting data for error dispensers (including deposited drop positioning errors); (iii) if there is no error in one or more operating parameters then the apparatus is operated according to the target drive pattern; (iv) if there is an error in one or more dispensers then processor 140 derives, based on the error, a corrected drive pattern from the target pattern such that firing by error dispensers is replaced by firing from non-error dispensers. The evaluation for deposited drop positioning errors may be based on capturing one or more images of the deposited drops by sensor 304. Additionally or at the same time, sensor 304 may capture one or more images of the structures and the processor 140 can use the relative positions of the structures to determine the deposited drop positioning errors for formulation of the corrected drive pattern. In this manner the position at which drops are to be deposited may be determined with a high degree of accuracy. The target or corrected drive pattern may be saved in memory or just derived during the actual array fabrication and sent as instructions directly to the apparatus components. Drops are dispensed in accordance with this corrected drive pattern in coordination with movement of the head system 210. Head system 210 is then reloaded and the foregoing procedure repeated until all drops for the arrays are deposited. During drop deposition, the structures may act to confine drops ejected onto the front surface 11a to the desired locations for features 16.

A loading sequence for head system 210 is more completely described in U.S. Pat. No. 6,323,043 and U.S. Pat. No. 6,242,266, including the possibility of using a flexible microtitre plate as described in U.S. patent application “Method and Apparatus for Liquid Transfer”, Ser. No. 09/183,604. Those references and all other references cited in the present application, are incorporated into this application by reference. Processor 140 can control pressure within head system 210 to load each polynucleotide solution into the chambers in the head by drawing it through the orifices as described in one or more of the foregoing patents or applications.

Substrate 10 is then loaded onto substrate station 20, if not previously loaded, either manually by an operator, or optionally by a suitable automated driver (not shown) controlled, for example, by processor 140.

The deposition sequence is then initiated to deposit the desired arrays of polynucleotide containing fluid droplets on the substrate to provide drops on the substrate according to the target pattern each with respective feature locations and dimensions. As already mentioned, in this sequence processor 140 will operate the apparatus according to the target or corrected drive pattern, by causing the transport system to position head system 210 facing substrate station 20, and particularly the mounted substrate 10, and with head system 210 at an appropriate distance from substrate 10. Processor 140 then causes the transport system to scan head system 210 across substrate 10 line by line (or in some other desired pattern), while co-coordinating activation of the ejectors in head system 210 so as to dispense droplets as described above. If necessary or desired, processor 140 can repeat the load, dispense drops in test pattern, dispense drops in corrected drive pattern, one or more times until head system 210 has dispensed droplets in to obtain the target arrays 12 to be formed on substrate 10.

At this point the droplet dispensing sequence is complete.

Following receipt by a user of an array made by an apparatus or method of the present invention, it will typically be exposed to a sample (for example, a fluorescently labeled polynucleotide or protein containing sample) and the array then read. Reading of the array may be accomplished by illuminating the array and reading the location and intensity of the resulting fluorescence at each feature of the array. For example, a scanner may be used for this purpose which is similar to the AGILENT MICROARRAY SCANNER manufactured by Agilent Technologies, Palo Alto, Calif. Other suitable apparatus and methods are described in U.S. patent applications: Ser. No. 09/846125 “Reading Multi-Featured Arrays” by Dorsel et al.; and Ser. No. 09/430214 “Interrogating Multi-Featured Arrays” by Dorsel et al. As previously mentioned, these references are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,251,685, U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample, or whether or not a pattern indicates a particular condition of an organism from which the sample came). The results of the reading (processed or not) may be forwarded (such as by communication) to a remote location if desired, and received there for further use (such as further processing).

When arrays 12 are read by illuminating the features in a scanner, as described above, feature locations in a detected light image may be identified based at least in part on the locations of the structures. That is, since the locations of the structures are known and may provide a strong signal in the detected light image, feature locations in the light image (which may only provide a weak signal in the image) may be determined using this information. In a simple case where each feature is circumscribed by a structure, this is a fairly simple process (that is, the feature is probably has a same width as the circumscribed region). If the structures are lines only, then they will aid in positioning the features in the image in one dimension only. One way of accomplishing this is by use of the methods described in U.S. Pat. No. 5,721,435 (which as previously mentioned, is incorporated herein by reference).

Given that the structures may produce too strong a detected light signal in response to illumination during reading of an array 12, it may be desirable to decrease the illuminating light intensity at locations of the structures, versus the illuminating light intensity provided to the features 16. Techniques for accomplishing this are described in U.S. Pat. No. 6,406,849.

The present methods and apparatus may be used to deposit biopolymers or other chemical moieties on surfaces of any of a variety of different substrates, including both flexible and rigid substrates. Preferred materials provide physical support for the deposited material and endure the conditions of the deposition process and of any subsequent treatment or handling or processing that may be encountered in the use of the particular array. The array substrate may take any of a variety of configurations ranging from simple to complex. Thus, the substrate could have generally planar form, as for example a slide or plate configuration, such as a rectangular or square or disc. In many embodiments, the substrate will be shaped generally as a rectangular solid, having a length in the range about 4 mm to 1 m, usually about 4 mm to 600 mm, more usually about 4 mm to 400 mm; a width in the range about 4 mm to 1 m, usually about 4 mm to 500 mm and more usually about 4 mm to 400 mm; and a thickness in the range about 0.01 mm to 5.0 mm, usually from about 0.1 mm to 2 mm and more usually from about 0.2 to 1 mm. However, larger substrates can be used, particularly when such are cut after fabrication into smaller size substrates carrying a smaller total number of arrays 12.

In the present invention, any of a variety of geometries of arrays on a substrate 10 may be fabricated other than the rectilinear rows and columns of arrays 12 of FIG. 1. For example, arrays 12 can be arranged in a sequence of curvilinear rows across the substrate surface (for example, a sequence of concentric circles or semi-circles of spots), or in some other arrangement. Similarly, the pattern of features 16 may be varied from the rectilinear rows and columns of spots in FIG. 2 to include, for example, a sequence of curvilinear rows across the substrate surface (for example, a sequence of concentric circles or semi-circles of spots), or some other regular pattern. Even irregular arrangements are possible provided a user is provided with some means (for example, an accompanying description) of the location and an identifying characteristic of the features (either before or after exposure to a sample). In any such cases, the arrangement of dispensers in head system 210 may be altered accordingly. The configuration of the arrays and their features may be selected according to manufacturing, handling, and use considerations.

The substrates will typically be non-porous, and may be fabricated from any of a variety of materials. In certain embodiments, such as for example where production of binding pair arrays for use in research and related applications is desired, the materials from which the substrate may be fabricated should ideally exhibit a low level of non-specific binding during hybridization events. In many situations, it will also be preferable to employ a material that is transparent to visible and/or UV light. For flexible substrates, materials of interest include: nylon, both modified and unmodified, nitrocellulose, polypropylene, and the like, where a nylon membrane, as well as derivatives thereof, may be particularly useful in this embodiment. For rigid substrates, specific materials of interest include: glass; fused silica; plastics (for example, polytetrafluoroethylene, polypropylene, polystyrene, polycarbonate, and blends thereof, and the like); metals (for example, gold, platinum, and the like).

The substrate surface onto which the polynucleotide compositions or other moieties are deposited may be smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated).

Various further modifications to the particular embodiments described above are, of course, possible. Accordingly, the present invention is not limited to the particular embodiments described in detail above.

What is claimed is:

1. A method of fabricating an array of different chemical moieties having at least one thousand features at respective locations, comprising ejecting drops containing the different moieties or precursors thereof from an orifice in an ejector head onto a substrate surface spaced from the orifice so as to form the array, the substrate surface having structures adjacent each of multiple feature locations so as to assist in confining drops ejected onto the surface to the feature locations, which structures comprise channels or deposited raised members adhering to the surface and extending above adjacent feature locations.

1a. A method according to claim 1 wherein the structures comprise channels.

2. A method according to claim 1 wherein drops ejected onto the surface for at least some features initially extend at least partly over the structures and then move off the structures.

3. A method according to claim 1 wherein during a same cycle a series of drops are ejected from the head onto the surface for a same feature while the head and substrate surface are in motion with respect to one another.

4. A method according to claim 1b wherein the series of drops is ejected from the same orifice.

4b. A method according to claim 1 additionally comprising determining the position of one or more of the structures and determining the position at which drops are to be deposited for the features based on the determined position of the one or more structures.

4c. A method according to claim 4b wherein the position of the structures are determined based on imaging the one or more structures.

5. A method according to claim 1 wherein the structures have a width of no greater than Wmax1.

6. A method according to claim 1 wherein the structures have a width of no less than Wmin1.

7. A method according to claim 1 wherein the structures have a thickness of no greater than Tmax1.

8. A method according to claim 1 wherein the structures have a thickness of no less than Tmin1.

9. A method according to claim 5 wherein the structures comprise deposited raised members adhering to the surface which members comprise a deposited metal.

10. A method according to claim 1 wherein one or more drops ejected onto the surface during a cycle for a feature having an adjacent channel or raised barrier have a total volume of no more than 10 microliters.

11. A method according to claim 1 wherein one or more drops ejected onto the surface during a cycle for a feature having an adjacent channel or raised barrier have a total volume of no more than 5 microliters.

12. A method according to claim 1 wherein the structures circumscribe multiple regions each of which includes only one feature.

13. A method according to claim 12 wherein one or more drops ejected onto the surface for a feature during a cycle occupy an area on the surface less than the area of the region which includes that feature.

14. A method according to claim 1 wherein the channels or deposited raised barriers do not circumscribe feature locations.

15. A method according to claim 12 wherein the structures are in the form of a grid with each region having an area no greater than 1 mm².

15a. A method according to claim 1, additionally comprising exposing the array to a sample and detecting light emitted from individual array features on the substrate surface having the structures.

15b. A method according to claim 15a additionally comprising illuminating the array with in interrogating light and reading the light emitted from individual array features in response to the interrogating light.

16. An array of different chemical moieties having at least one thousand features at respective locations on a planar substrate surface having structures comprising channels or deposited raised barriers adhering to the surface, and which structures are adjacent each of multiple feature locations.

17. An array according to claim 16 wherein the structures have a width of no greater than Wmax1.

18. An array according to claim 17 wherein the structures have a width of at least Wmin1.

19. An array according to claim 16 wherein the structures have a thickness of no greater than Tmax1.

20. An array according to claim 19 wherein the structures have a thickness of at least Tmin1.

20a. An array according to claim 16 wherein the structures comprise deposited raised barriers adhering to the substrate surface.

21. An array according to claim 16 wherein the deposited raised barriers adhering to the surface comprise a deposited metal.

22. An array according to claim 16 wherein the structures circumscribe multiple regions each of which includes only one feature.

23. An array according to claim 16 wherein a feature occupies an area on the surface less than the area of the circumscribed region which includes that feature.

24. An array according to claim 16 wherein the channels or deposited raised barriers do not circumscribe feature locations.

25. An array according to claim 16 wherein the channels or raised barriers are in the form of a grid with each region having an area no greater than 1 mm².

26. A method of reading an array of claim 16 following exposure to a sample, comprising detecting light emitted from the array substrate with the surface having the structures.

27. A method according to claim 26 additionally comprising illuminating the array and detecting the light emitted in response to the illumination.

28. A method according to claim 26 additionally comprising identifying feature locations in a detected light image based at least in part on the locations of the structures.

29. A method according to claim 27 wherein the illuminating light intensity is decreased at locations of the structures.
